(19) United States
(12) Patent Application Publication
(10) Pub. No.: US 2022/0044353 A1
(43) Pub. Date: Feb. 10, 2022

(54) SYSTEM AND METHOD FOR REDUCING JITTER WHEN PROVIDING AN INDICATION FOR A RELATIVE DIRECTION OF ANOTHER DEVICE

(71) Applicant: HISEP TECHNOLOGY LTD., YAVNE (IL)

(72) Inventors: YARIV ERAD, KIDRON (IL); GAD VERED, BE'ER YA'AKOV (IL); URI VERED, RISHON LEZION (IL); MENACHEM ERAD, ASHDOD (IL)

(21) Appl. No.: 17/372,566

(22) Filed: Jul. 12, 2021

Related U.S. Application Data
(60) Provisional application No. 63/063,348, filed on Aug. 9, 2020.

(51) Int. Cl. G06T 3/20

(52) U.S. Cl. CPC G06T 3/20

(57) ABSTRACT

A method for reducing jitter including defining multiple areas on a display coupled to an electronic device, where each area of the multiple areas is associated with a range of optional relative directions between a target device relative and a measuring device, periodically computing a relative direction of the target device relative to the measuring device, assigning the computed relative direction to one of the multiple areas, and displaying an indication of the relative direction within a specific area of the multiple areas that matches the computed relative direction.

### FIELD

The invention relates to reducing jittering of displaying an indication resulting from computing a relative direction of another device, more specifically to displaying an indication to a relative direction of another device.

### BACKGROUND

When computing a relative position or a relative direction of another object or device, often a jittering phenomenon occurs on a display that shows the relative direction and/or relative position. The relative position of another device is based on a relative direction in addition to a distance to the other device. Several things influence the jittering effect: the refresh frequency—the faster it is, the more updated positions are displayed. 2. DF accuracy—the higher the accuracy, the bigger the ability to differentiate in angles regarding the relative direction of a Target device. 3. DF reliability—many DF systems, devices and techniques suffer from reflections, multipaths, effects of Line-of-Sight (LOS) and non-LOS, and other interreferences. These disturbances can change given the applied Frequency (of the RF/light/audio) of the wave, and applied wireless communication protocol (if applied), HW & SW effects, shielding and isolations, DF orientation, antennas polarization—and many more. The effect is the same—the displayed direction will not be the sufficiently accurate.

From the user's perspective, these jitters can cause the Target to “jump” in the display, even if in real-life the target did not move, nor did the displaying device or measuring device moved significantly. For the user, the jitter effect can be bothersome when looking at the display. This problem is more significant when there is a plurality of Targets displayed, each target moves on the display. It can also cause lack of trust in the reliability of the relative direction detection means. As more and more companies try to achieve higher accuracy of relative direction, while trying to integrate DF components and techniques into small form-factor electronic devices such (but not limited to) smart phones, smart watched, IoT devices, etc.—the effect of Jittering will become significantly bigger.

For example, in a possible use case there is an electronic device such as an iPhone™ or iWatch™ with a DF (attached or integrated). The users of such devices are not stationary. They move, they rotate—their whole body, limbs, hands, and the Target can move as well. The result is that the Relative direction of a Target vs the DF can change very frequently. As the DF accuracy is higher, the amount of movement/rotation, that can cause a change in the direction of the Target, is smaller. See for example a comparison regarding the effect of DF accuracy from different form-factors devices. Assuming an electronic device with DF capabilities having a 1-degree accuracy, even a small rotation of 0.05 cm means that the Target is no longer in the same direction vs the DF.

This means that the displayed Relative direction needs to be updated accordingly—which mean for the user, this very small movements on the display that cause a jittering effect, while de-facto the general Relative direction of the Target does not change.

Another aspect that effects the Jittering is the distance between the Looker and the Target. All these phenomena and effects are eventually translated to a user interface that needs to be easy to use, intuitive—especially when there are many Targets. This problem intensifies for very short-range wireless communication protocols and frequencies—such as UWB that operates at 3 Ghz and above and enables a direction-finding range of around 10 meters. For such protocols and frequency, that claims to enable high accuracy distance measurements and high accuracy relative direction finding, the problem of display Jittering will be more noticeable.

### SUMMARY

The invention, in embodiments thereof, discloses methods and user interfaces for reducing the display accuracy of a relative direction of a target object or device relative to the measuring device. The measuring device is not necessarily the displaying device. The reduced accuracy is used to improve the user experience when finding a relative direction of the target and reduce Jittering.

In one aspect of the invention a method is provided for reducing jitter when providing an indication for a relative direction of another device, including defining multiple sectors on a display coupled to an electronic device, each area of the multiple sectors is associated with a range of optional relative directions between a target device relative and a measuring device, periodically computing a relative direction of the target device relative to the measuring device, assigning the computed relative direction to one of the multiple sectors, determining whether or not to move the indication from one sector to another sector based on a set of rules, displaying an indication of the relative direction within a specific area of the multiple sectors that matches the computed relative direction and the set of rules.

In some cases, the method includes moving the indication on another sector of the multiple sectors when the computed relative direction exceeds the range of optional values associated with the specific sector.

In some cases, the indication is constant for multiple values in the range of optional relative directions of the specific sector. In some cases, the indication is constant for all the values in the range of optional relative directions of the specific sector. In some cases, the relative direction is computed relative to a heading of the measuring device

In some cases, the indication is displayed in another sector of the multiple sectors only upon a predefined number of consecutive computations determining that the relative direction is associated with another sector. In some cases, the method further includes identifying outliers from a set of relative direction computations and removing the outliers from the set of relative direction computations when determining whether or not to remove the indication from the specific sector to another sector. In some cases, the method further includes determining to move the indication from the specific sector to another sector when an average value of a set of multiple relative direction computations is associated with the another sector. In some cases, the average is a moving average. In some cases, determining to move the indication from the specific sector to another sector when a predefined number of relative direction computations from a set of relative direction computations are associated with the range of optional values associated with the another area.

In some cases, the method further includes updating the number of sectors to be displayed on the display coupled to the electronic device. In some cases, updating the number of sectors based on an input from a user of the electronic device. In some cases, updating the number of sectors is based on a predefined event. In some cases, all the sectors are of the same size. In some cases, the display includes four sectors, each sector consumes a quarter of the display. In some cases, the method further includes computing a distance between the target device relative to the measuring device.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-1C show a display device showing a target vs. the DF's heading, according to exemplary embodiment of the invention;

FIGS. 2A-2C show multiple postures of holding a display device showing a target vs. the DF's heading, according to exemplary embodiment of the invention;

FIG. 3 shows a method of displaying a target vs. the DF's heading, according to exemplary embodiment of the invention; and,

FIGS. 4A-4C show a person looking for a specific target and how the display device shows the target on a user interface of an electronic device, according to exemplary embodiment of the invention.

### DETAILED DESCRIPTION

The term “Relative Position” refers to the relative direction and/or relative distance and/or relative elevation of a Target Vs a Looker (DF). Said Relative Position can be in 360 degrees or in a specific direction or sector of interest.

The term “Jittering”—refers to the fluctuations of the displayed Relative Position or relative direction of an icon and/or symbol in a Relative Positioning display and/or GUI and/or UI and/or App.

The term “Sector”—refers to a geometric area bounded by two radii and the included arc of a circle. Said sector can be in relation to the Looker's Heading. Said sector can be different is size/angle.

The term “Direction finder or DF or Looker” refers to a device and/or object and/or thing having Wireless Communication means (such as, but not limited to, IOT) with a one or more antenna, or with at least one antenna array, which is used to determine the relative direction to a Target as defined herein under. Alternatively, the device is used to find whether one or more Targets are located within a desired direction from the finder. Said DF can be a stand-alone device or integrated into another electronic device, either via software or hardware or a combination of both. A Looker device can also function as a Target. Said Looker may include a compass component and/or Accelerometer and/or Gyro and/or Tilt sensors and/or an AM.

The term “Target” refers to a device and/or object and/or thing having Wireless Communication means (such as, but not limited to, IOT), or an RF communication source, which comprises RF transmitter and/or receiver and/or repeater or transponder and/or tag, which communicates wirelessly directly (i.e., not via relays) with the DF, and which also comprises an Antenna Module. A Target device can also function as a Looker. Said Target may include a compass component and/or Accelerometer and/or Gyro and/or Tilt sensors.

The term “Heading” refers to a virtual pre-determined direction, in relation to a physical element in the Target or Looker device, that will be regarded as the “zero-point heading” of the AM and will be used to illustrate the “Heading” Target or looker device. Said Heading can correlate with a device's display shape or position.

The term “Tilt sensor” refers to a device and/or component that can measure the tilting in often two axes of a reference plane in two axes, in portable electronic devices—such as, but not limited to, cellular phone, video game controllers/console, digital camera, GPS device, media player, laptop computer, tablet computer, wireless remote control, PDA—to detect the position of the device or provide for game input.

The term “Absorbing Material”—shall refer to the weakening and/or reduction in strength and/or attenuation of a wireless signal/wave—all of it or part of it—that occurs as it passes through objects and/or lossy medium and/or materials with dielectric loss properties (such as, but not limited to, the human body and/or materials with absorbing properties). Said absorbing material may have pre-defined properties corresponding with the wave type and/or frequency it is aimed to delay. Said absorbing material can be natural (for example—but not limited to, a human body part) or artificial, can be synthetic or machine-made, can be composed of different layers or different materials;

The term “electromagnetic time delaying material”—shall refer to materials that can increase the length of time taken for a RF wave and/or sound wave and/or light wave to travel from a Target to a Looker via Wireless Communication. Said electromagnetic time delaying Material may have pre-defined properties corresponding with the wave type and/or frequency it is aimed to delay. Said electromagnetic time delaying material can be natural (for example—but not limited to, a human body part, wood, metals, vegetation, fluids, gases, animals) or artificial, can be synthetic or machine-made (such as, but not limited to, structures, chemical composites, ceramics, advanced materials, etc. . . . ), can be composed of different layers or different materials. Said electromagnetic time delaying materials may include means to enable controlled change of the delay time. Said Delaying Material can be an Absorbing Material. The electromagnetic time delaying material may be defined as Propagation delay materials or Time of flight delaying materials or wave velocity decreasing materials or Delaying Materials or DM.

The terms “Time-of-Flight” or “TOF” or “TOA” refer to the measurement of time duration taken by an object, particle or wave (be it acoustic, electromagnetic, light etc.) to wirelessly travel a distance through a medium.

The terms “time of arrival” or “TOA” these terms shall refer to the absolute time of arrival at a Looker or to the measured time difference between departing from a Target and arriving at the Looker. The distance/path length between a Looker and a Target can be directly calculated from the time of arrival as a Wireless Communication wave travels with a known velocity.

The terms “Round Trip Time” or “RTT” or “TWR”—shall refer to the length of time it takes for a signal to be wirelessly sent plus the length of time it takes for an acknowledgement of that signal to be received, for example received at the device that sent the signal. This time includes propagation time for the paths between the Target and a Looker. This information can then be used to measure velocity or path length. TOA or TOF can be applied to calculate the RTT and distance.

The terms “Line-of-sight” or “LOS”—shall refer to the characteristic of electromagnetic radiation propagation (including RF and light) or acoustic propagation which means waves travel in a direct path from a Target to a Looker.

The terms “None-Line-of-Sight” or “near-LOS”, or “NLOS”—shall refer to events in which the rays or waves may be delayed due to the presence of an electromagnetic time Delaying Material in the direct path (in whole or in part of the path) of the Wireless Communication between the Target and the Looker.

The term “Wireless Communication”—shall refer to the transfer of information and/or data (of all kinds, such as—but not limited to—voice, image, video, laser, analog or digital and/or packets (formatted blocks of data) and/or communication acknowledgment/no-acknowledgment and/or voice over long or short distances without the use of electrical conductors or “wires” but via Radio waves and/or light waves and/or sound waves, at any given frequency.

The terms “Wireless Communication Protocol” and/or “Standard”—shall refer to any protocol and/or standard used to conduct Radio and/or light and/or sound using Wireless Communication, such as, but not limited to, wireless Information Technology, cellular communication (such as, but not limited to, GSM, GPRS, CDMA), Wireless Networks, WLAN computer communications, wireless networking standards (such as IEEE 802.11), wireless personal area networks (WPAN) and wireless mesh networks, and “Internet-of-Things”. It should be clearly stated that among such protocols, but not limited only to them, are Wi-Fi, Bluetooth, Low-Energy-Bluetooth (BLE), Wi-Max, ZigBee, Z-wave, Insteon, UWB, Cellular devices communication protocols, Near-field Communication (NFC), RFID protocols or standards. These terms shall also refer to the use of such protocols over any radio frequency, such as—but not limited to, UHF, HF, VHF, 2.4 Ghz, 5 Ghz, 18 Ghz, 60 Ghz UWB-dedicated frequencies, and up to 300 Ghz.

The terms “Antenna Module” or “Antenna Array”, or “AM” shall refer to a system and/or a device comprising at least one antenna and/or an array of antennas that can be used to either transmit and or receive radio signals in pre-defined antenna patterns. Said arrays patterns can be of any type of known arrays used for radio direction-finding, including, but limited to, directional, monopulse, cardioids. Said antenna patterns can be created using variety of components and/or antenna types, shapes and sizes.

The term “Ground”—shall refer to a conducting surface close to an antenna used to enable an antenna to function and/or improve the antenna performance and/or increase the probability of acquiring a required antenna radiation pattern. For example, said Ground can be (but not limited to) a metallic surface located beneath a monopole antenna.

The terms “Communication Circuit” or in short “Comm”—shall refer to an RF and/or light and/or sound transmitter and/or receiver which communicates wirelessly with one or more Targets. The Comm may be (but not limited to) e.g., Wi-Fi, Bluetooth, ZigBee, UWB, and RFID etc. at any frequency.

The terms “Identification Data” or “ID”—shall refer to a number, either serial or other, a name, a collection of symbols, or any other type of reference used to provide an electronic device a unique identification, which enables users and/or systems to identify, track, monitor, and operate the device. Said ID may be originally provided by the devices manufacturers, may be assigned to it by a computer system, may be assigned by a user, or may be used simply to associate a unique description by a user to the device. A device may also have more than one ID's attached to it (for example, by the manufacturers, by the system, and by the user). A device may also broadcast different IDs at different statuses (for example, ID1 for “stand-by”, ID2 for “operating”);

The terms “Target Compass Azimuth” or “Target AZ” shall refer to compass bearings that are stated in the Target's system in which either north or south can be the zero, and the angle may be measured clockwise or counterclockwise from the zero.

The terms “Looker Compass Azimuth”, or “Looker AZ” shall refer to compass bearings that are stated in the Looker's system in which either north or south can be the zero, and the angle may be measured clockwise or counterclockwise from the zero.

The term “AZ” refers to Azimuth with respect to the north, having a range of 0≤AZ<360.

The term “ϕ” refers to a direction with respect to the Heading (either the Looker's Heading or the Target's Heading), having a range of −180≤ϕ<180

The terms “Internet-of-Things” or “IOT”—shall refer to physical objects or “things” embedded with electronics, software and/or sensors and Wireless P2P Communication connectivity to enable it to connect with other devices. Each thing is locally uniquely identifiable through its embedded computing system but is might be able to interoperate within the existing Internet infrastructure. Such thing does not have to include a display mean.

The terms “Peer-2-peer” or “P2P”—shall refer to a Wireless Communication network between at least 2 wireless devices, which allows wireless devices to directly communicate with each other. Said Wireless devices within range of each other can discover and communicate directly without involving central access points. This term also covers the use of Wireless Communication between a cellular device to a Base-station, Base-station to Cellular device, and Base-Station to Base-station. It also covers, in the same manner, TV stations Wireless Communication.

The term “Accelerometer”—shall refer to a device that measures proper acceleration—i.e., the acceleration experienced relative to freefall. Single- and multi-axis models are available to detect magnitude and direction of the acceleration as a vector quantity, and can be used to sense position, vibration and shock. Said accelerometer can be a component and/or sensor in portable electronic devices—such as, but not limited to, cellular phone, video game controllers/console, digital camera, GPS device, media player, laptop computer, tablet computer, wireless remote control, PDA—to detect the position of the device or provide for game input.

The term “Gyroscope” shall refer to a device for measuring or maintaining orientation, based on the principles of conservation of angular momentum. Said Gyroscope can be a component and/or sensor in portable electronic devices—such as, but not limited to, cellular phone, video game controllers/console, digital camera, GPS device, media player, laptop computer, tablet computer, wireless remote control, PDA—to detect the position of the device or provide for game input.

The term “Cross Verification” shall refer to a mode of operation of the system, in which the Target and Looker devices can each change functionality—i.e., the Target becomes the Looker and the Looker becomes the Target, and when doing so the method switches between the Reversed DF method to prior-art DF methods.

The term “Sensors” shall refer to any type of sensors, such as, but not limited to, Barometer, pressure sensors, light sensors, medical sensors, touch sensors, camera sensor, radar sensor, etc.

The terms “POLOC” or “Point of loss of communication” shall refer to the measurable point in which the wireless communication between the Target and Looker is lost, in accordance with the various methods and techniques desired by a person skilled in the art.

The invention discloses a method for displaying a relative direction and/or a Relative Position of a target object on a display device. The relative direction may be defined by sectors extending from a center of an imaginary circle, the center represents the location of the measuring device. The relative position is computed based on the relative direction and a distance between the measuring device and the target device. The subject matter discloses both options, of a relative direction, and a relative position. In some exemplary cases, an indication of a relative direction is displayed after associating the computed relative direction to a sector. An indication of a relative position is displayed after associating the computed relative direction to an area. The method comprises defining multiple areas on a display coupled to an electronic device, each area of the multiple areas is associated with a range of optional relative directions between a target device relative and a measuring device. The areas may be sectors, or other forms or areas, such as polygon-shaped areas. Then, periodically computing a relative direction of the target device relative to the measuring device and assigning the computed relative direction to one of the multiple sectors according to the values allocated to each area. Then, the method comprises displaying an indication of the relative direction within a specific area of the multiple areas that matches the computed relative direction. The areas may be of a polygonal shape, elliptical shape, may have a shape of a sector, defined between two radii and an arc, and any other shape and size desired by a person skilled in the art. The areas may be of the same size, or different sizes.

The method may be used to display multiple target objects concurrently on the same display device. Each target may be displayed with an identifier, such as a name, a number, a tag and the like. The target objects may be devices, persons or animals, vehicles, items coupled to sensors and the like.

Computing a relative direction and/or a relative position of the target device relative to the measuring device may be performed by a Looker device or a measuring device. Such device may comprise or integrated to or connected to or be in wired or wireless communication with an electronic device that comprise a display, a memory, a processor, a power source such as a battery, a user interface for displaying a Relative Position or relative direction, such as a graphical user interface (GUI). The Looker device or a measuring device may also comprise sensors, such as tilt sensors. The electronic device can be of any type, form-factor, size—such as, but not limited to—smartphone, smart-watch, tablet, camera, smart speaker, headphones, TOT device, home appliance, TV, laptop, etc.

In some exemplary cases, the multiple sectors may be quarters of a circle, each quarter represents a sector expending from the circle's center according to the looker device's heading, as follows: the first sector represents front & right directions, (1-90 degrees from the heading), the second sector represents back & right directions, (91-180 degrees from the heading), the third sector represents back & left directions, (181-270 degrees from the heading) and the fourth sector represents front & left directions, (271-360 degrees from the heading).

In some exemplary cases, the indication of the target's Relative Position or relative direction is displayed in a fixed position within each area of the multiple areas. For example, if the Looker computes the relative direction of a Target to be at either 28, 7, 60, 78, 55, 12 degrees, the Target will be displayed at 45 degrees in Q1—i.e., the middle of the sector, in all these instances. The indication may be displayed at any given angle in an area or a sector—not necessarily the center of the sector. In some cases, Targets can be displayed at the 0(360)/90/180/270) angles, to represent that they are located at the Front-only, right-only, back-only or left-only Relative Position or relative direction vs the Looker.

In some cases, the indication may consume the entire area, to be more visible to the user of the device in which the relative position or relative direction is shown. For example, marking the area associated with the target's relative position or relative direction in black while the other areas are in white.

In some cases, the target's relative position or relative direction is computed periodically, for example once every 1 millisecond to once every 100 seconds. When the computed relative position or relative direction is associated with another area, the indication is displayed on another area. For example, when the interface has four sectors as explained above and the measured relative position or relative direction is represented as a set of degrees as follows [20, 15, 32, 85, 75, 80, 105], the indication will be displayed in the first sector in the first six measurements, and after measuring 105 degrees, the indication will be displayed in the second sector.

In some cases, displaying the indication in another area is determined only after computing multiple consecutive values associated with the other area, for example three consecutive measurements. For example, in a set of measurements of degrees as follows [20, 15, 32, 85, 75, 80, 105, 90, 85, 82, 92, 102, 70], all the indications will be displayed in the first area. In another example, in the set of measurements of degrees as follows [20, 15, 32, 85, 95, 110, 105, 80, 85, 92, 92, 102, 70], the indications will be displayed in the first area until measuring 110 degrees, which is the third consecutive measurement associated with the second area, and the indication will remain in the second area until the end of the set. The number of consecutive measurements required to move the indication between areas can be defined or set per Target type, for example people, places, products, devices, sensors, IOT and the like.

The number of consecutive measurements may be set per the distance of the Target from the Looker device. The number of consecutive measurements may be set per application type (for example, but not limited to, navigating to a Target vs explore what's around the Looker's device in 360 degrees). The number of consecutive measurements can be set for specific targets (for example, for a child in a child locator application and/or device. The number of consecutive measurements can enable jittering to better reflect real-time Relative Position or relative direction of the child.

In some cases, the computed relative position or relative direction measurements are inputted into a function, and the output of the function dictates whether or not to move the indication to another area of the multiple areas. The function may compute an average of the measurements, a moving average, or any other arithmetic function desired by a person skilled in the art. For example, move to the second quarter only if the average of the last five measurements is between 91-180.

In some cases, the method comprises identifying an outlier in the computed relative position or relative direction measurements. The outlier may be defined as an unreasonable Relative Position or relative direction measurement. The outlier may then be discarded and not inputted into the function. For example, measured Relative Position or relative direction can be the following set of angles—45,60,70,270, 80,75, in which 270 is an outlier. The outlier may be defined mathematically, for example as a value that deviates more than 20 degrees from 4 previous consecutive measurements.

In some cases, the indication is displayed in another area in case a predefined number of measurements out of a set of predefined number of direction measurement have determined that the Target is in a Relative Position or relative direction other than the area it was previously displayed at. For example, by determining that at least 8 our 10 measurements showed the Target to be in a different area—the indication will be displayed in the other area. This computation may run on consecutive sets of measurements, for example measurements 1-10, then measurements 2-11, then 3-12 and so on.

The number of sectors may vary as desired by a person skilled in the art. The number of areas may be determined by a user of the Looker device, or a user of the user interface in which the indication is displayed. In some cases, the number, size and shape of the areas may change in response to an event, for example according to information received from a sensor, according to a distance measured between the Looker device and the target, and the like.

The areas, or sectors, may be displayed versus the heading of the Looker device. In some cases, the areas may represent other settings, for example to represent different angle range based on clustering of Relative Position or relative direction determinations. For example, a set of relative direction measurement may fluctuate around a Quarter boundary—i.e., measured direction can be a set of degrees as follows: [85, 95, 87, 98, 90, 93, 89]. In such case, there might be a problem to associate the Relative Position or relative direction to a specific Quarter and the user interface may adjust the sectors, for example to include angles from 45 to 135 degrees, and the Target may be displayed without Jittering at 90 degrees. The method may be applied in events where such fluctuation occurs between predefined sectors and can use predefined threshold of fluctuating boundaries—for example if the clustering occurs within a predefined range of angles—in the example above between 80-100 degrees.

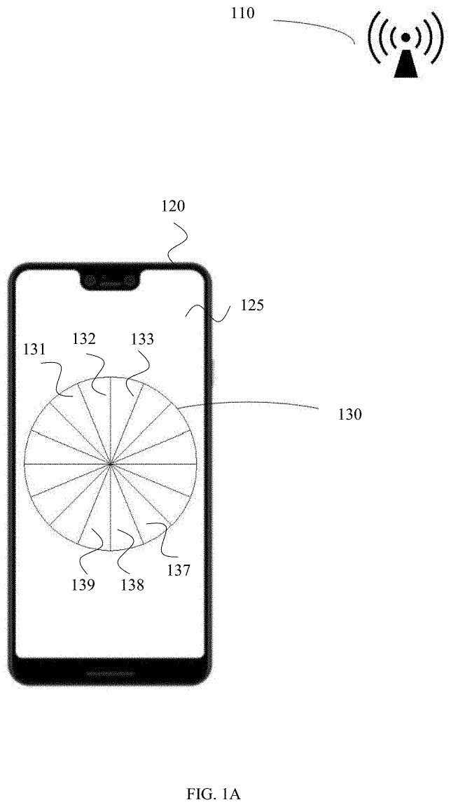

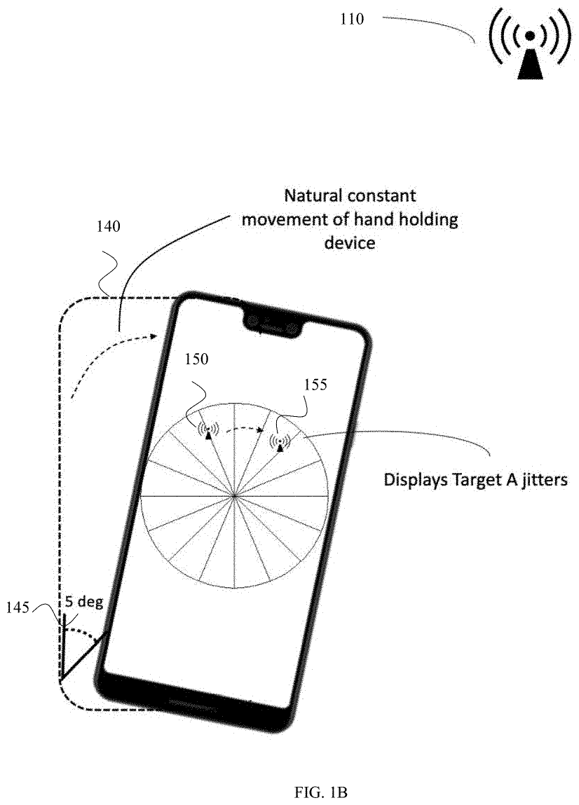

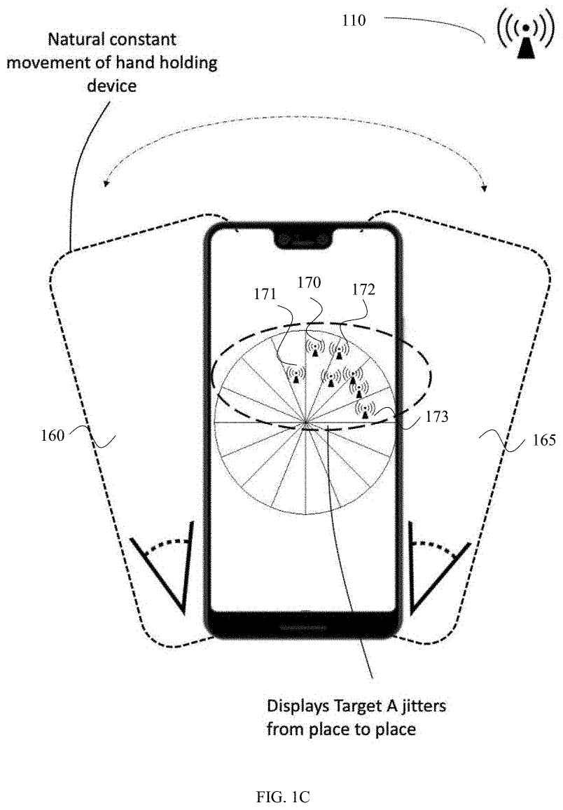

FIGS. 1A-1C show a display device showing a target vs. the DF's heading, according to exemplary embodiment of the invention. FIG. 1A shows a looker device 120 and a target device 110. At least one of the looker device 120 and the target device 110 compute a relative position or relative direction of the target device 110 from the heading of the looker device 120. The computed relative position or relative direction may be performed using direction-finding techniques as defined above.

The computed relative position or relative direction is associated with an area of a user interface displayed on a display 125 of the looker device 120. In some cases, the relative position or relative direction may be displayed on another device, not the looker device 120. The user interface has multiple areas, such as multiple areas 131, 132, 133, 137, 138 and 139. The areas may be sectors of a circle. The circle enables a user of the looker device to intuitively direct herself or navigate towards the target device 110. The areas 131, 132, 133, 137, 138 and 139 are assigned to different ranges of relative positions or relative directions. For example, in case there are 10 identical sectors, each sector is associated with a range having 36 degrees. For example, area 131 is associated with computed relative position or relative direction having angles 288-324 from the heading of the looker device 120, area 132 is associated with computed relative position or relative direction having angles 324-360 from the heading of the looker device 120 and area 133 is associated with computed relative position or relative direction having angles 0-36 from the heading of the looker device 120. In some cases, when the computed relative position or relative direction of the target device 110 is 12 degrees from the heading of the looker device 120, the indication of the target device 110 will be displayed on the area 133. Similarly, when the computed relative position or relative direction of the target device 110 is 300 degrees from the heading of the looker device 120, the indication of the target device 110 will be displayed on the area 131.

FIG. 1B shows a natural movement of the looker device 120, for example when carried by a person's palm. The looker device 120 moves 5 degrees clockwise from an original position 140 of the looker device. In prior art methods, this would result in jitter of the indication of the target device 110 on the display device 125, for example from point 150 to point 155. According to the method of the subject matter, the indication may remain in the same area even after the movement of the 5 degrees, as long as the new position is associated with the same area of the multiple areas 131, 132, 133, 137, 138 and 139.

FIG. 1C shows a looker device 120 moving from left position 160 to right position 165. The movement may cause from natural movement of the user holding the looker device 120. FIG. 1C shows the jitter effect that was very common in prior art methods, in which the indication was provided in exactly the relative direction of the target device. As long as the time elapsing between subsequent relative position or relative direction computations is shorter than the time elapsing when the user moves the looker device, the indication appears in multiple points on the device. For example, in points 170, 171, 172, 173 on the display device. The subject matter prevents this jitter by displaying the indication on a single point as long as all the relative position or relative direction computations are associated with a single area, or as long as the differences in the relative position or relative direction computations do not require to display the indication in another area, for example according to the rules or functions disclosed above.

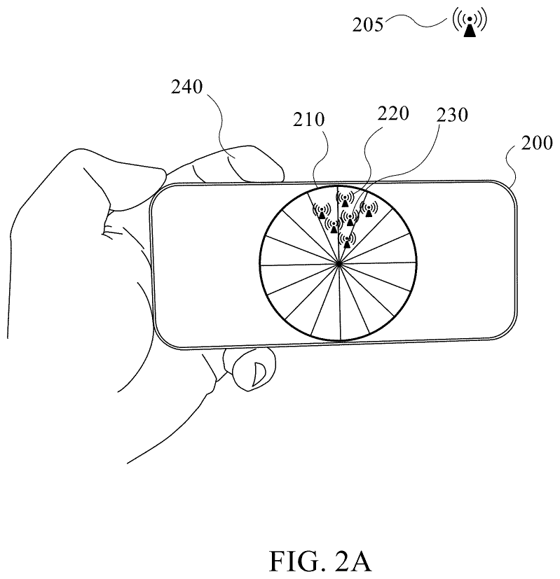

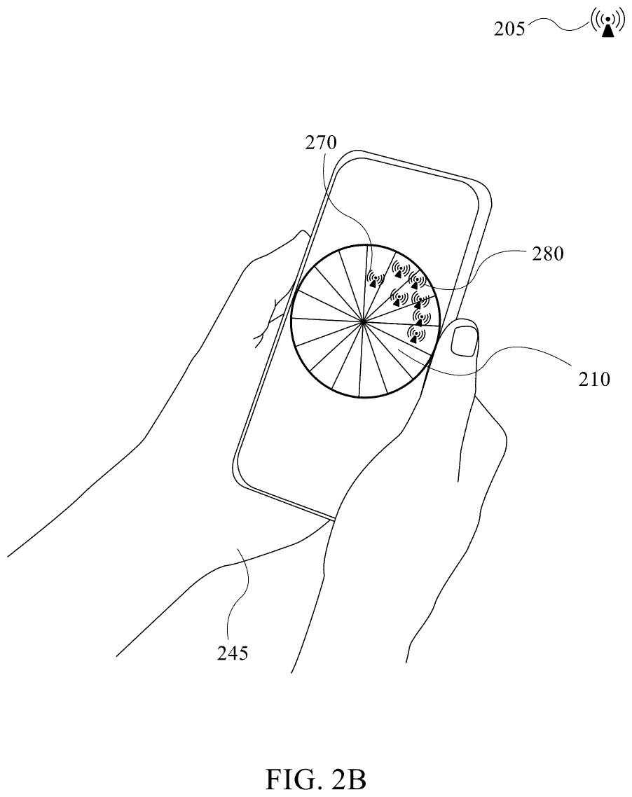

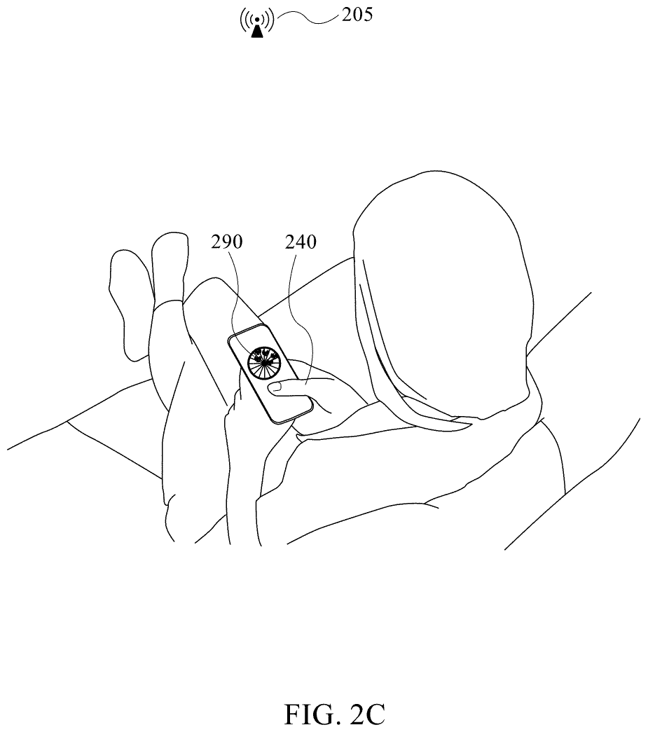

FIGS. 2A-2C show multiple postures of holding a display device showing a target vs. the DF's heading, according to exemplary embodiment of the invention. In FIG. 2A, the looker device 200 is held by the user's palm 240. The looker device 200 displays a relative position or relative direction of the target device 205 on a display device thereof. The user interface showing the relative position or relative direction is divided into sectors, as the indication of the target device 205 is displayed on one of the sectors. FIG. 2B shows sectors 270, 280 on the display device of the looker device 200. The heading 220 may be defined as a front direction of the device, from the top most end of the device. In FIG. 2C, the user holds the looker device 200 when sitting.

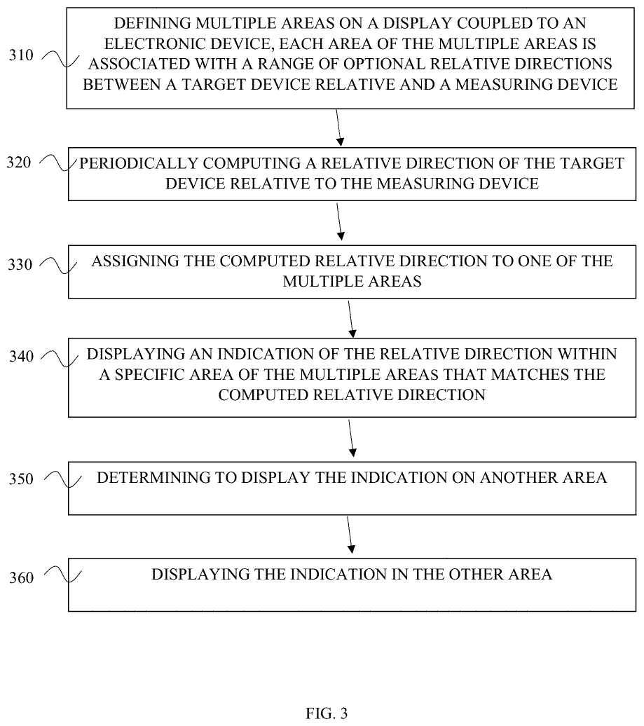

FIG. 3 shows a method of displaying a target vs. the DF's heading, according to exemplary embodiment of the invention.

Step 310 discloses defining multiple areas on a display coupled to an electronic device, each area of the multiple areas is associated with a range of optional relative directions between a target device relative and a measuring device. The ranges may be equal or different. For example, the areas closer to the heading may have less degrees than the areas on the sides. In some cases, the range of relative position or relative direction measurements is from zero (0) to 360 degrees, and the 360 degrees are uniformly split among the multiple areas, for example in the formula 360/N, as N defines the number of areas.

Step 320 discloses periodically computing a relative direction of the target device relative to the measuring device. The computation may be performed once every time duration desired by a person skilled in the art. The time duration, or frequency of computation, may change according to an event, for example according to a distance between the looker device and the target device. The relative direction may be computed according to signal strength, time of flight of a signal, and other techniques as desired by a person skilled in the art.

Step 330 discloses assigning the computed relative direction to one of the multiple areas. The assigning is performed according to the range of values associated with each area and a set of rules. For example, in case there are six equal sectors and the computed relative direction is 72 degrees right from the heading, the area assigned is area #2.

Step 340 discloses displaying an indication of the relative direction within a specific area of the multiple areas that matches the computed relative direction. The indication may be constant in the selected area, regardless to the computed value in the area. For example, in case there are six areas, the indication remains the same when angle representing the computed relative direction is either 66, 84, 117, 95 and the like. The indication may comprise an identifier or another representation specific to the target, such as a name, nickname, logo, number, symbol, and the like.

Step 350 discloses determining to display the indication on another area. Such determination is done after computing the relative direction of the target. In some cases, once the computed relative direction is associated with another area, the indication will immediately be displayed in the other area. In some other cases, the indication will move to another area only in case a set of relative directions computed over time satisfies a rule, for example that an average is associated with the other area, or that multiple consecutive values are associated with the other area.

Step 360 discloses displaying the indication in the other area. The display is similar to the display of step 340.

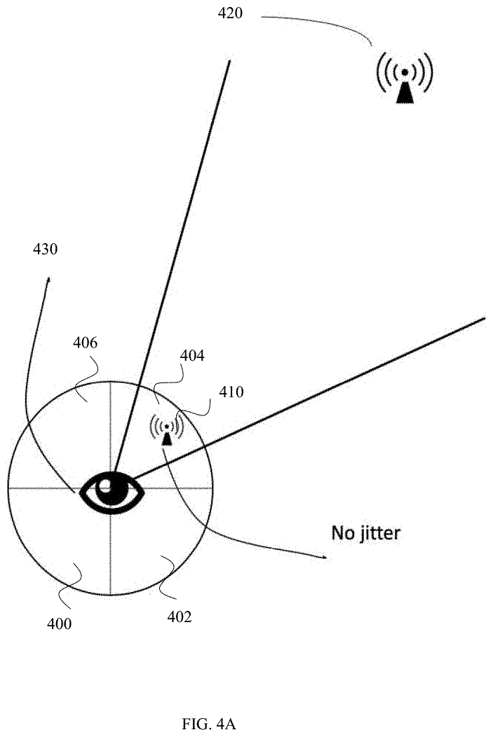

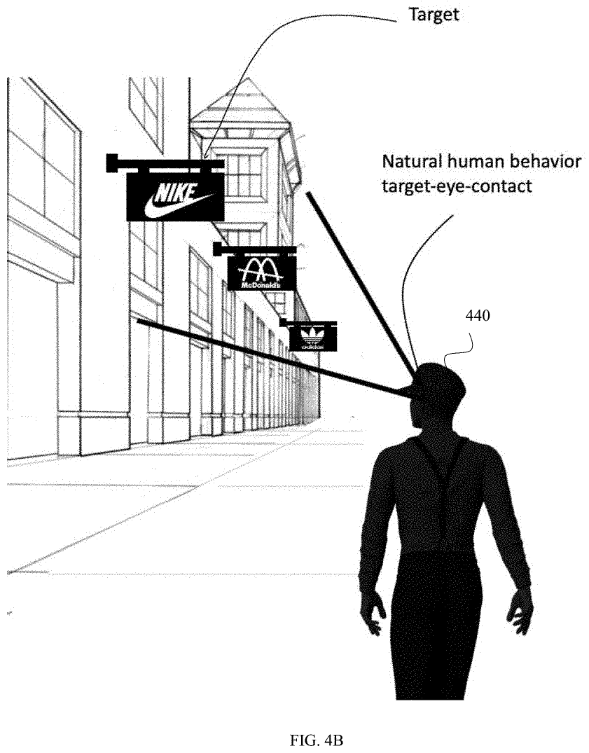

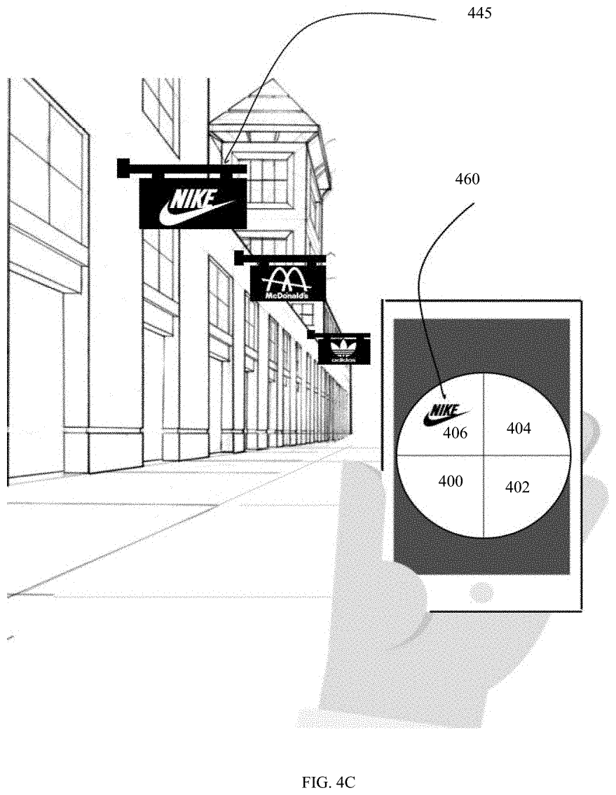

FIGS. 4A-4C show a person looking for a specific target and how the display device shows the target on a user interface of an electronic device, according to exemplary embodiment of the invention. The user interface is of a circular shape, having four sectors 400, 402, 404, 406, equal in size. The indication 410 of target device 420 is displayed on sector 404. The center of the user interface shows an eye 430 symbolling the user's eyes or direction of sight of the looker device used by the user. FIG. 4B shows a person 440 walking in a street, searching for a target which is a street sign by “Nike” 445. The looker device used by the person 440 computes a relative position or relative direction of the street sign 445 from the looker device and displays the relative position or relative direction on a user interface on an area or sector that matches the relative position or relative direction. For example, as shown in FIG. 1C, the indication 460 is displayed in section 406, meaning that the street sign 445 is located ahead and left from the user 440. The indication 460 may comprise an identifier of the target, as shown in the logo of “Nike” displayed in the section 406.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. A method for reducing jitter when providing an indication for a relative direction of another device, comprising:
defining multiple sectors on a display coupled to an electronic device, each area of the multiple sectors is associated with a range of optional relative directions between a target device relative and a measuring device;
periodically computing a relative direction of the target device relative to the measuring device;
assigning the computed relative direction to one of the multiple sectors;
determining whether or not to move the indication from one sector to another sector based on a set of rules; and
displaying an indication of the relative direction within a specific area of the multiple sectors that matches the computed relative direction and the set of rules.

2. The method of claim 1, wherein providing the indication on another sector of the multiple sectors when the computed relative direction exceeds the range of optional values associated with the specific sector.

3. The method of claim 1, wherein the indication is constant for multiple values in the range of optional relative directions of the specific sector.

4. The method of claim 1, wherein the indication is constant for all the values in the range of optional relative directions of the specific sector.

5. The method of claim 1, wherein the relative direction is computed relative to a heading of the measuring device

6. The method of claim 1, wherein the indication is displayed in another sector of the multiple sectors only upon a predefined number of consecutive computations determining that the relative direction is associated with another sector.

7. The method of claim 1, further comprising identifying outliers from a set of relative direction computations and removing the outliers from the set of relative direction computations when determining whether or not to remove the indication from the specific sector to another sector.

8. The method of claim 1, further comprising determining to move the indication from the specific sector to another sector when an average value of a set of multiple relative direction computations is associated with the another sector.

9. The method of claim 8, wherein the average is a moving average.

10. The method of claim 8, wherein determining to move the indication from the specific sector to another sector when a predefined number of relative direction computations from a set of relative direction computations are associated with the range of optional values associated with the another area.

11. The method of claim 1, further comprising updating the number of sectors to be displayed on the display coupled to the electronic device.

12. The method of claim 11, wherein updating the number of sectors based on an input from a user of the electronic device.

13. The method of claim 11, wherein updating the number of sectors based on a predefined event.

14. The method of claim 1, wherein all the sectors are of the same size.

15. The method of claim 14, wherein the display comprises four sectors, each sector consumes a quarter of the display.

16. The method of claim 1, further comprising computing a distance between the target device relative to the measuring device.
